(19) United States
(12) Patent Application Publication
(10) Pub. No.: US 2002/0098077 A1
(43) Pub. Date: Jul. 25, 2002

(54) Removable wheelchair lift assembly

(76) Inventor: William Edward Beech, Beaufort, SC (US)

Correspondence Address: KATHLEEN M HARLESTON, THE HARLESTON LAW FIRM, 909 TALL PINE ROAD, MT PLEASANT, SC, 29464

(21) Appl. No.: 09/769,792

(22) Filed: Jan. 25, 2001

(51) Int. Cl. B66B 9/08; B66B 9/06

(52) U.S. Cl. 414/921; 187/201; 187/245

(57) ABSTRACT

A removable lift assembly for moving a wheelchair or other heavy object over an outdoor set of steps includes:

(a) a frame assembly comprised of two longitudinal halves, the two halves being mirror images of each other, the frame assembly comprising at least two guide rails, the guide rails being affixed to the inside of the frame assembly;

(b) a lift platform assembly comprising a substantially flat platform,

(c) a mechanism for guiding the platform along the guide rails over the steps; and

(d) a source of power for moving the platform up and down the steps;

wherein the frame assembly is installable over the steps without attachment to the steps or to any adjacent structures, and wherein the lift assembly does not impede conventional usage of the steps.

### BACKGROUND OF THE INVENTION

1. Technical Field

The present device is a removable, easy to install lift assembly for moving a wheelchair or another heavy object over steps outdoors.

2. Background Information

Existing inventions include ramps and lifts that require permanent installation and attachment to building or stairway structures. Ramps and mechanized lifts typically require expensive and permanent alteration to structures and landscaping. Existing lifts for lifting wheelchairs and the like up and down a set of stairs are ill-suited for outdoor use. Commercially available wheelchair lifts are expensive and must be permanently installed. A permanently installed wheelchair lift may limit access to stairs and damage the house when it is removed. Conventional wheelchair lifts for temporarily lifting a wheelchair over a set of stairs leading to a house or other building are not readily available. People who are in a wheelchair short-term, and family members or caretakers who temporarily have a wheelchair-bound person living with them, for example, must permanently install a lift or employ creative measures for the period in question.

Thus, there is a need for an inexpensive wheelchair lift which can be easily installed over a staircase and removed with minimal damage to landscaping and existing structures. The present invention satisfies that need with an inexpensive, easily installed, removable wheelchair lift that does not require permanent attachment to existing structures (noninvasive) and can easily be adapted to fit different houses and stairways.

The present invention is a lift assembly for moving a wheelchair, wheeled dolly, or heavy object, such as a refrigerator or furniture, up or down a stairway. The device comprises, generally: a drive assembly, frame assembly, and a four-wheeled platform dolly. This lift assembly can be installed on outdoor steps without side-walls, and with any different number of steps. The lift platform is moved up and down the stairs by means of a motor with sprocket and chain assembly installed externally. The lift assembly can be installed by one person in about an hour. No attachment to the structure of the steps or building, or any alterations to the landscaping, is necessary. This assembly can be easily removed and therefore serves to provide access for people who are temporarily disabled. The lift platform may also be equipped with automatic safety gates to prevent unintended exit from the platform while in operation.

Another benefit of the lift assembly of the present invention is that the stairs beneath the lift assembly can be used even when the lift assembly is installed. When the lift platform is not in use, it is positioned at ground level. An ambulatory person can step onto the platform and from there onto the bottom step.

### BRIEF SUMMARY OF THE INVENTION

The present invention is a removable, noninvasive lift assembly for moving a wheelchair or other heavy object over a set of steps. The assembly comprises:

(a) a frame assembly comprised of two longitudinal halves, the two halves being mirror images of each other, the frame assembly comprising at least two guide rails, the guide rails being affixed to the inside of the frame assembly;

(b) a lift platform assembly comprising a substantially flat platform, and

(c) a mechanism for guiding the platform along the guide rails over the steps; and

(d) a source of power for moving the platform up and down the steps;

wherein the frame assembly is installable over the steps without attachment to the steps or to any adjacent structures, and wherein the lift assembly does not impede conventional usage of the steps.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a perspective view of a wheelchair lift assembly according to the present invention, showing a lift platform in a lowered position;

FIG. 2 is an exploded perspective view of a portion of a wheelchair lift assembly according to the present invention, showing the frame assembly;

FIG. 3 is a top plan view of a lift platform assembly according to the present invention;

FIG. 4 is a perspective view of a hydraulic power unit for a wheelchair lift according to the present invention; and

FIG. 5 is a side elevational view of a portion of a wheelchair lift assembly according to the present invention, showing a platform safety gate latch mechanism;

FIG. 6 is a side elevational view of a portion of a wheelchair lift assembly according to the present invention, showing up and down platform switches; and

FIG. 7 is a perspective view of a wheelchair lift assembly according to the present invention.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

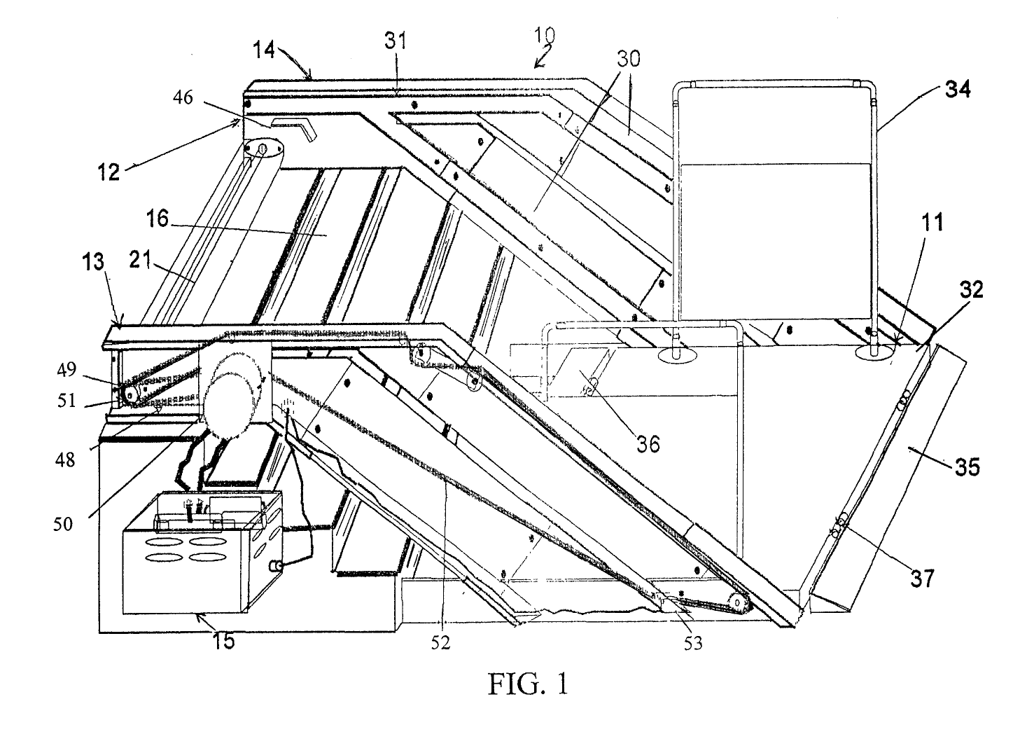

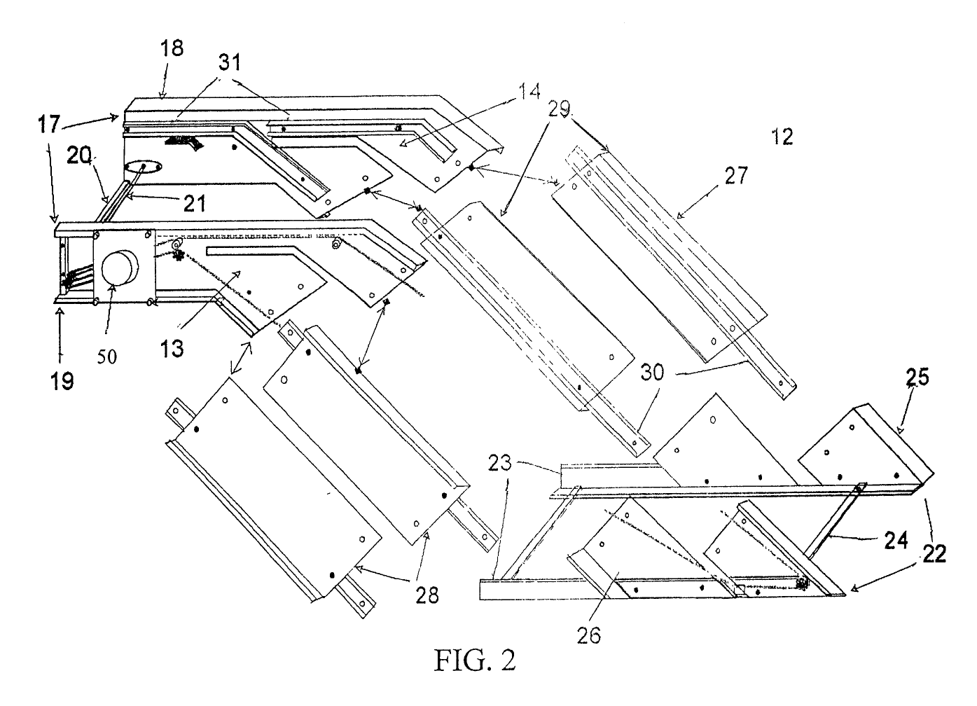

Turning first to FIGS. 1 and 2, a lift assembly, generally referred to as 10, for lifting or lowering wheelchairs and other heavy objects comprises: a lift platform assembly 11; a frame assembly 12 having a right half 13 and a left half 14; and a mechanism for moving the platform assembly up and down the stairway, preferably a hydraulic power unit assembly 15. The two halves of the frame assembly 12 are substantially mirror images of each other. The right half 13 of the frame assembly is installed over the right stairwell of the steps 16 to be covered by the lift assembly 10, and the left half 14 is installed over the left stairwell of the steps 16.

Continuing to refer to FIGS. 1 and 2, each half 13, 14 of the frame assembly is comprised of three sections. The frame assembly is preferably self-supporting, and is especially useful over a set of steps without side walls. If the stairway to be covered has low walls on either side of the stairs, the frame assembly rests on the steps. The invention is most preferably for use on a conventional staircase with between about two and five stairs, such as the brick or treated wood steps leading to the front or back stoop of manufactured homes, modular homes, or brick houses.

As shown in FIGS. 1 and 2, the frame assembly has an upper section, which is the drive assembly 17, which comprises left and right frame units 18, 19, respectively. The left and right frame units 18, 19 are connected to one another by a support brace 20, which is attached at either end to the frame units 18, 19, and a lift chain drive shaft 21, which also extends between the frame units. The frame assembly is preferably comprised of C-shaped frame rails along both sides of the upper section, and L-shaped rails along both sides of the lower section.

Referring to FIG. 2, the lower section of the frame assembly is a base assembly 22, which is comprised of two identical angle iron foot pieces 23 connected by two identical tie bars 24, with left and right frame pieces 25, 26, respectively, mounted as shown. The middle frame section 27 of the frame assembly extends between the upper, drive assembly 17 and the lower, base assembly 22.

The middle frame section 27 is fabricated of substantially identical sets of right and left middle section support units 28, 29, respectively. The middle section may be of various dimensions to fit various location height requirements. The middle section support units are adjustable so that longer middle frame sections can be used over taller staircases with more stairs (e.g., four or five), and shorter middle frame sections can be used over shorter staircases with fewer stairs (e.g., two or three). Even once a lift assembly has been used over a set of stairs at one home, it can be dissembled, transported to another set of stairs in the same home or a different building, and assembled there. An even number of matching units may be added to lengthen the middle section, hence the lift assembly is adjustable for different numbers of steps.

To use the lift assembly 10, a wheelchair or other object to be lifted is positioned on the lift platform 11, which is shown in FIG. 1. The lift assembly is operable by the wheelchair occupant, or by a second person standing nearby. At the lowered position shown in FIG. 1, the lift platform 11 rests on the ground at the bottom of the stairs 16, ready for use.

As shown in FIGS. 1 and 2, the frame assembly 12 is further comprised of at least two guide rails. Of these, there are preferably four horizontally level C-type guide rails 31 in the upper frame section 17, and four inclined C-type guide rails 30 in the middle frame section 27. An upper end of each inclined C guide rail 30 is attached to a lower end of each level C guide rail 31 to form sloped tracks. These tracks run along either side of the stairs 16 along the inside of the frame. The inclined C guide rails 30 generally run parallel to one another above the stairs 16, and the level C guide rails 31 generally run parallel to the ground and to any stoop at the top of the stairs. Inclined C guide rails 30 are attached across the sets of left and right middle section support units 28, 29, as shown in FIG. 2. The horizontally level C guide rails 31, which are attached to the drive assembly 17, support the lift platform at the top of travel (i.e., in the “upper” position). The inclined guide rails 30, like the middle section support units 28, 29 to which they are attached, may be of various dimensions to fit various location height requirements.

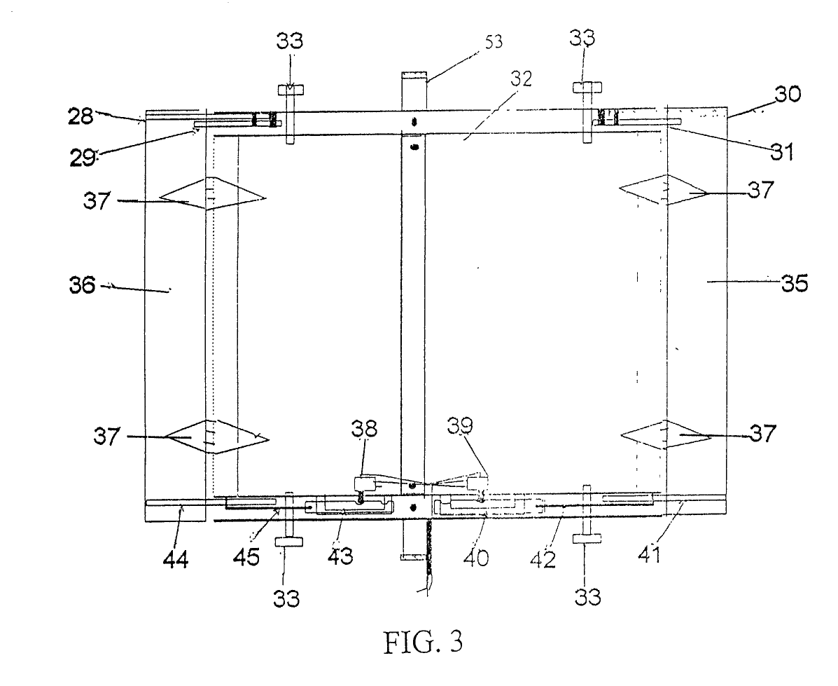

Referring to FIGS. 1, 2 and 3, the lift assembly 10 comprises a lift platform assembly 11, which comprises a substantially flat platform 32 and a mechanism for guiding the platform along the guide rails. The mechanism for guiding the platform preferably comprises at least four wheels 33, with at least two of the wheels being movably affixed to two opposite sides of the platform at corresponding positions. One set of guide rails is affixed to each side of the frame assembly. Each set of guide rails includes two C-shaped, inclined guide rails, which are substantially parallel to each other. One of the wheels 33 fits movably into each C-shaped guide rail 30, 31. The wheels 33, which are preferably between about 2 and 3 inches in diameter, are mounted on the sides of the lift platform 11, with two wheels at corresponding points on each side, as shown in FIG. 3. The lift assembly is mounted on these wheels 33, which movably fit within the inclined and level C-type guide rails 30, 31.

As shown in FIG. 1, the platform assembly preferably includes a set of hand rails 34. The bottoms of the hand rails are affixed to the platform 32 on either side. The hand rails are preferably the height of the arms of a conventional wheelchair. A control switch may be mounted to the top of the handrail within reach of the wheelchair occupant.

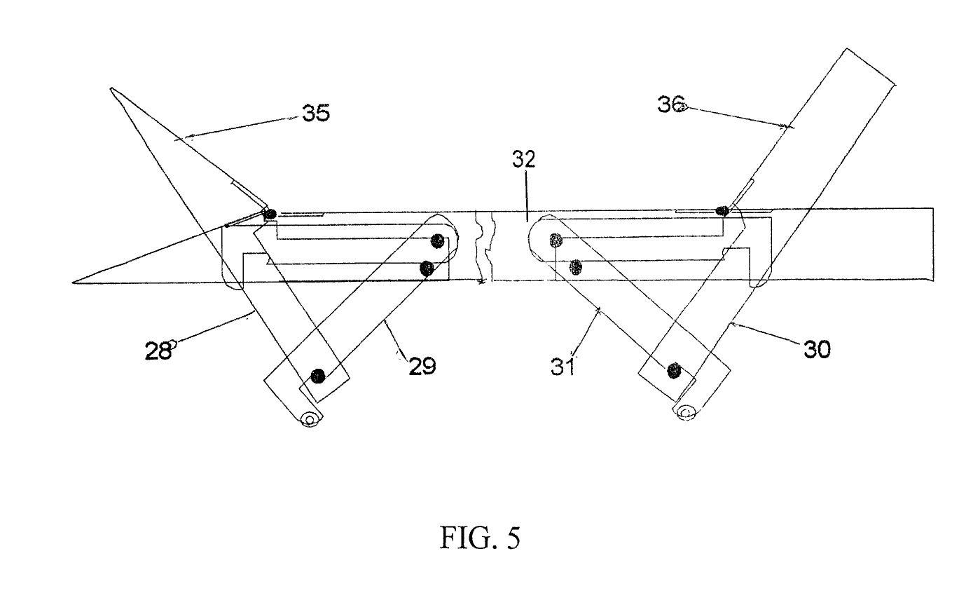

As shown in FIGS. 1 and 5, the platform assembly includes two safety gates 35, 36, or ramps, one on each end of the platform 32. Each safety gate preferably extends the width of the platform. Both safety gates flip up once the wheelchair or other object is in place and the platform starts to rise. They prevent the object on the platform from sliding off the platform. The safety gate 35 on the front, entrance end of the platform 32 is inclined to allow the wheelchair, or hand truck wheels, to easily mount the platform. The rear safety gate 36, which is on the opposite, exit end of the platform, can also be an inclined ramp, but it is preferably squared to conveniently abut a door jamb on the stoop/top step, once the platform rises. It could also be inclined, though, if desired. Both safety gates are preferably mounted to the platform by spring loaded hinges 37, so both gates automatically flip up during platform travel. The safety gates 35, 36 close to the up position during platform travel by means of spring loaded hinges 37, and they latch into position by pivoting safety ramp latches 28-31 attached to one side of the lift platform. As shown in FIG. 5, the safety latch mechanism automatically latches the safety gates once they are in an up position. The automatic safety gate latching mechanism, then, comprises at least two safety gates 35, 36, spring loaded hinges 37, and safety latch bars 28-31. The safety latch bars are movably attached to the ends of the safety gates. The safety gates are movably attached to opposite ends of the platform 32 by the spring loaded hinges 37. The safety gates are adapted to automatically close when the platform is in motion, and the safety latch bars are adapted to keep the safety gates in a closed position until the platform comes to rest.

The up and down movement of the platform 32 is controllable by two platform switches 38, 39, which are affixed under the platform along one side of the platform. One switch 38 controls upward motion of the platform, and the other switch 39 controls downward motion.

Turning now to FIGS. 1, 3 and 6, when at rest, the platform 32 is on the ground and both safety gates 35, 36 are in the down (open) position. A first switch cam 40 is mechanically linked to the front safety gate 35, preferably by a first rigid metal rod 42 connected to a first connecting lever 41 (on the side opposite the safety latch), turns on the up platform switch 38, and turns off the down platform switch 39. A second switch cam 43 is linked to the rear safety gate 36, preferably by a second connecting lever 44 connected to a second rigid metal rod 45, and controls the down platform switch 38.

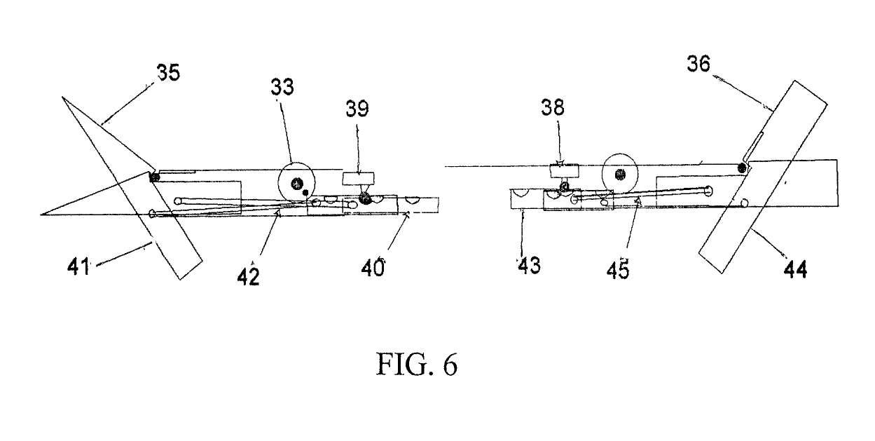

In operation, the platform 32 moves upward, guided by the wheels 33 in the guide rails 30, 31. Spring action hinges 37 raise and latch both gates 35, 36, as shown in FIGS. 3 and 6. At the top of travel, the rear safety gate 36 is automatically unlatched and lowered by contacting a cam plate 46 mounted on the drive assembly. When the rear safety gate 36 is lowered, the second switch cam 43 connected to the safety gate 36 opens the up platform switch 38, which stops upward travel. The opening of the safety gates (i.e., down position) turns off the up and down platform switches 38, 39.

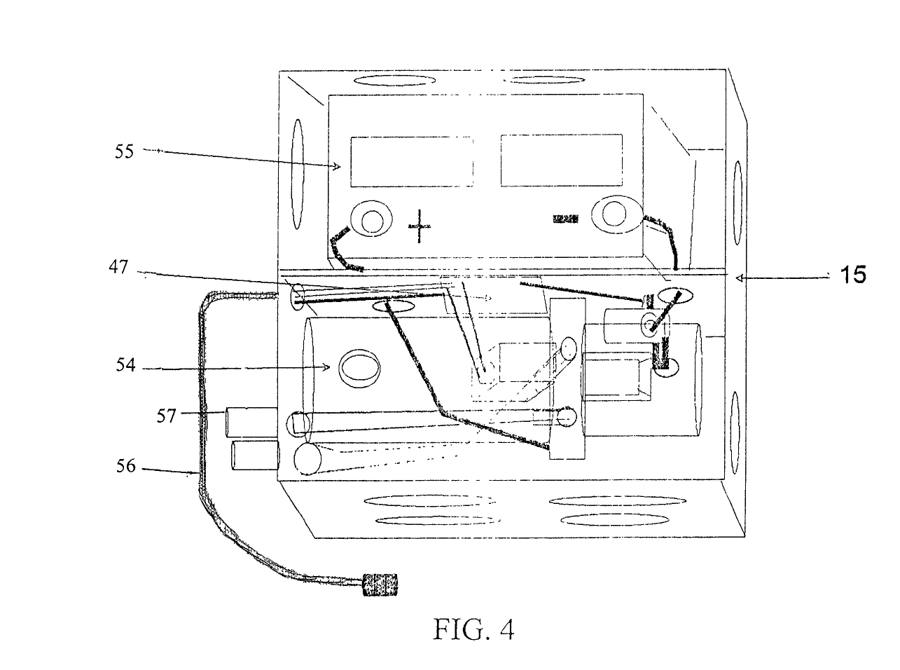

As shown in FIG. 4, the control unit 47 remains in the up mode at the top of travel, with motor action stopped by open up switch 38, awaiting the activate signal. When the control unit 47 receives the activate signal, it changes to the down mode, starting motor via down switch 39, and the platform 32 moves down. Spring action hinges 37 automatically raise and latch the rear safety gate 36. As the platform reaches ground level, both safety gates 35, 36 are unlatched and lowered. The switch cam 42 linked to the front safety gate 35 opens the down platform switch 38, which stops downward travel. The platform 32 remains at rest until the next cycle.

When it is at the top of the lift assembly 10, the lift platform 32 is in an “upper” position, for example, on the front stoop of the house. In this upper position, it is ready for lowering a wheelchair or other heavy object down to ground level. The user can “call” the lift platform 32 up to the upper position, or down to the lower position, by using a switch placed inside or outside the doorway leading to the stairs 16, or with a remote control. The lift platform can also be used to move other heavy objects, such as groceries, furniture, and heavy appliances, such as washers, dryers, and refrigerators, into or out of the house or other building.

When the lift platform is lowered, it travels away from the front door for a short way along the single tracks on either side of the stoop (guide rails 31). Then each track splits into an upper branch of the track and a lower branch of the track (guide rails 30), which is closest to the stairs, and the platform is lowered to ground level. The tracks are made up of the inclined and level guide rails. The front wheels of the platform, which are the ones closest to the stairs, travel along the lower branches of the tracks. The rear wheels of the platform, which are farthest from the stairs, travel along the upper branches of the tracks. The platform remains parallel to the ground during travel, so that the wheelchair is not tipped off.

With continued attention to FIGS. 1 and 2, a drive chain 48 and drive sprocket 49 couples the motor 50 to the drive shaft 21. The drive shaft 21 in turn is connected by motor sprockets 51 to lift chains 52 on each side of the platform 32. The lift chains 52 are connected to chain lift bars 53. The chain lift bars 53 are attached beneath the lift platform 32.

Referring to FIGS. 1 and 4, the lift assembly 10 preferably includes a power unit 15, which can be mounted on either side of the frame assembly 12. Alternatively, the lift assembly can be powered by an AC motor, or a DC motor. The mechanism for moving the platform up and down across the steps is preferably a power unit 15. The power unit 15 comprises a DC hydraulic pump 54, electronic control unit 47, 12-volt DC battery 55, control cable 56, and hydraulic couplers 57. The power unit 15 is attached by two hydraulic lines to the motor 50, which will preferably be mounted on the same side of the frame assembly as the power unit.

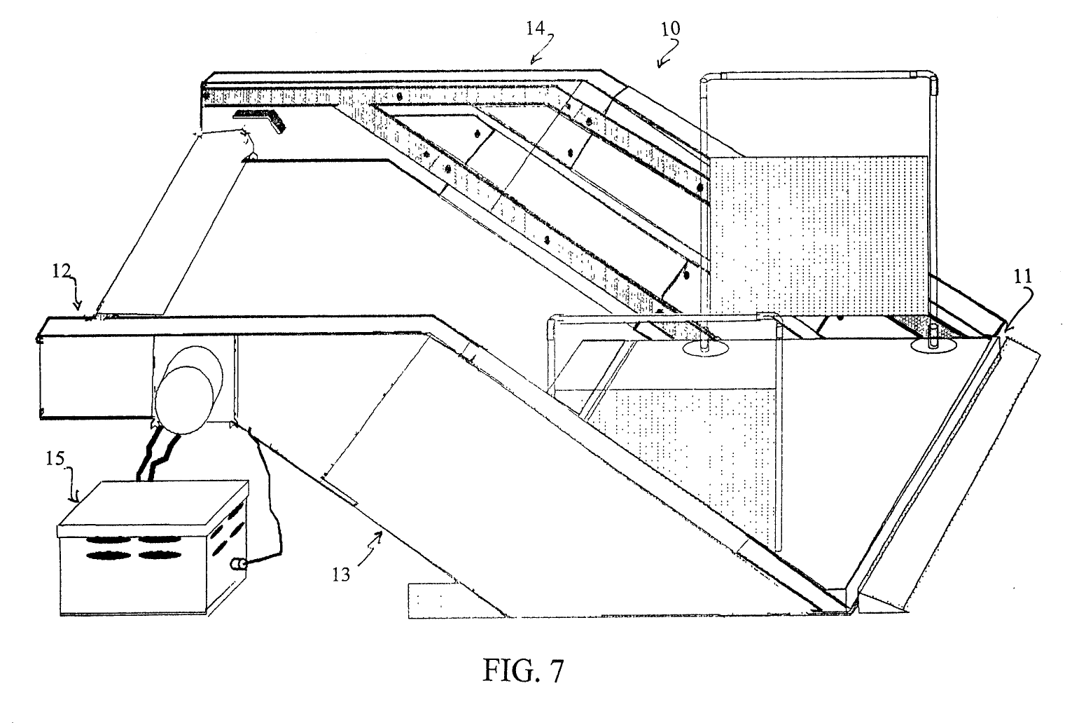

A complete lift assembly 10 is illustrated in FIG. 7, with cover plates installed over the frame assembly 12. The lift assembly 10 includes the frame assembly 12, hydraulic power unit 15, and the platform assembly 11. The frame assembly 12 includes the right and left halves of the frame assembly 13, 14. The platform 32 is in the down, ground level position.

From the foregoing it can be realized that the described device of the present invention may be easily and conveniently utilized as an assembly for moving wheelchairs and other heavy objects up and down stairways safely, without permanent installation or attachment to existing structures or alterations to landscaping and without impeding access to the stairs. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A removable lift assembly for moving a wheelchair or other heavy object over a set of steps, the assembly comprising:
(a) a frame assembly comprised of two longitudinal halves, the two halves being mirror images of each other, the frame assembly comprising at least two guide rails, the guide rails being affixed to the inside of the frame assembly;
(b) a lift platform assembly comprising a substantially flat platform,
(c) a mechanism for guiding the platform along the guide rails over the steps; and
(d) a source of power for moving the platform up and down the steps;
wherein the lift assembly is installable over the steps without attachment to the steps or to any adjacent structures, and wherein the lift assembly does not impede conventional usage of the steps.

2. A lift assembly according to claim 1, wherein the mechanism for guiding the platform comprises at least four wheels, with at least two of the wheels being movably affixed to two opposite sides of the platform at corresponding positions; wherein there are two sets of the guide rails, one set on each side of the steps, each set being comprised of two C-shaped, inclined guide rails which are substantially parallel to each other; and wherein at least one of the wheels fits movably into each of the C-shaped, inclined guide rails.

3. A lift assembly according to claim 2, wherein the frame assembly is comprised of three frame sections: an upper, or drive, section assembly; a lower, or base, section assembly; and a middle section connecting the upper section to the lower section; the middle section being adjustable for accommodating different numbers or heights of steps.

4. A lift assembly according to claim 3, wherein on and off ramps are attached to opposite ends of the platform, allowing easy access and exit by wheelchairs and other wheeled objects.

5. A lift assembly according to claim 3, further comprising an automatic safety gate latching mechanism comprising at least two safety gates, spring loaded hinges, and safety latch bars, the safety latch bars being movably attached to the ends of the safety gates, the safety gates being movably attached to opposite ends of the platform by the spring loaded hinges; wherein the safety gates are adapted to automatically close when the platform is in motion, and the safety latch bars are adapted to keep the safety gates in a closed position until the platform comes to rest.

6. A lift assembly according to claim 1, wherein the power source for moving the platform up and down comprises a hydraulic power unit, a drive shaft, and a chain assembly.

7. A lift assembly according to claim 4, wherein the platform assembly is equipped with cams to activate and deactivate up and down platform switches, causing platform movement to cease when the platform reaches the upper or lower level positions.

8. A lift assembly according to claim 5, wherein there are two of the safety gates, one at each end of the platform, each platform being attachedd by two spring loaded hinges.

9. A lift assembly according to claim 6, wherein the hydraulic power unit and a motor is mounted on the outside of one side of the frame assembly, adapted for activating and providing power to the drive shaft and chain assembly.

10. A lift assembly according to claim 6, wherein the motor and power unit may be controlled by a control panel or by remote control device, adapted for sole operation by a wheelchair occupant without assistance.
